(19) United States
(12) Patent Application Publication
(10) Pub. No.: US 2014/0222660 A1
(43) Pub. Date: Aug. 7, 2014

(54) METHOD FOR DETERMINING A BILL MIX IN AN ELECTRONIC CASH DISPENSER

(71) Applicants: JOHN C. HUANG, Las Vegas, NV (US); Bryan E. Bullard, Las Vegas, NV (US); George J. Vasilkos, Las Vegas, NV (US)

(72) Inventors: JOHN C. HUANG, Las Vegas, NV (US); Bryan E. Bullard, Las Vegas, NV (US); George J. Vasilkos, Las Vegas, NV (US)

(21) Appl. No.: 13/758,784

(22) Filed: Feb. 4, 2013

(51) Int. Cl. G06Q 20/18

(52) U.S. Cl. CPC G06Q 20/18
USPC 705/39

(57) ABSTRACT

A method for determining a bill mix in an electronic cash dispenser comprises: receiving a transaction request comprised of a transaction type and a dispense amount; evaluating the transaction type; evaluating the dispense amount; and determining the bill mix according to a dispense definition based on a plurality of criteria including transaction type and dispense amount. The method may further include evaluating day of the transaction request, time of the transaction request, patron information such as player tracking data, and/or bill inventory level. The method may also include receiving patron preference input. The dispense definition may comprise a minimum definition that defines a minimum quantity for each bill denomination to include in the bill mix. If a remainder exists after the minimum definition is applied to the dispense amount, the dispense definition may further comprises a remainder definition that calculates a remainder bill mix based on a least note methodology.

### FIELD OF THE INVENTION

The present invention relates to automated currency dispensers. More particularly, the present invention relates to a method and system for determining note denominations and quantities for each note denomination dispensed in an electronic cash dispenser.

### BACKGROUND

Electronic cash dispensers are used in connection with teller-assisted and cashier-assisted transactions. For instance, when a patron makes a withdrawal at a bank, the teller may retrieve the patron's cash from an electronic cash dispenser. In a casino establishment, a patron may conduct a check cashing transaction, cash out gaming chips, redeem gaming vouchers, break a large denomination bill into smaller denominations, or consolidate smaller bill denominations into larger denominations; and in such casino transactions, the casino cashier may use an electronic cash dispenser to retrieve the patron's cash. In some retail settings, the cashier may obtain cash change from a purchase or cash back from a debit card transaction via an electronic cash dispenser.

Additionally, electronic cash dispensers are implemented into various self-service kiosks that are capable of performing a variety of cash dispensing transactions. Such kiosks include, but are not limited to: automated teller machines (ATMs) that process cash withdrawals from bank accounts and credit card cash advances; change machines that process bill-break functions (i.e., converts an inserted bill into different denominations); currency exchange machines that convert inserted foreign currency into local currency; voucher redemption kiosks that cash out gaming vouchers and other types of credits; and bill payment, ticketing, retail, and vending kiosks that provide cash change from purchases or payments and/or provide cash back from debit card transactions. An example of a retail kiosk is a supermarket self-service checkout kiosk that provides cash change from purchases made by cash and provides cash back for purchases may with a debit card. Furthermore, some kiosks may perform multiple cash dispense functions (e.g., a single kiosk may process bill breaks and voucher redemption).

Some ATMs are owned by financial institutions such as banks or credit unions; and these ATMs are typically branded with the financial institution name, provide a number of banking functions that are offered at the financial institution branches, and are often found on bank property as well as at other locations for the convenience of their customers. On the other hand, there are ATMs and kiosks that perform various cash dispensing transactions that are not necessarily related to banking functions or tied to a banking account, and such kiosks are owned and/or operated by independent businesses (“kiosk providers”). These kiosks are typically found at various non-bank locations such as retail locations (e.g., convenience stores, grocery stores, and shopping malls), hotels, casinos, airports, train stations, restaurants, bars, nightclubs, gentlemen's clubs, concert venues, and sporting event venues to name a few.

Electronic cash dispensers typically contain an inventory of multiple bill denominations. During a dispense transaction, the system usually calculates the note denomination and pieces of notes to dispense based on available note inventory. The determination of note denomination and the quantities for each note denomination to be dispensed is referred to as “note selection” or “bill mix” determination. Currently there are two commonly used logics for bill mix determination:
(1) “Least Note” Method—This methodology is also known as “minimum bill mix” or “maximum denomination” and the calculation is based on the least number of notes possible to fulfill the transaction. For example, if a transaction request is comprised of a $100.00 dispense amount and the cash dispenser carries a maximum denomination of $50.00 bills, then two $50.00 bills would be dispensed pursuant to the least-note methodology. Accordingly, bills are dispensed using the largest possible denomination(s) contained in the cash dispenser's inventory to minimize the total number of dispensed bills.
(2) “Predetermined” Method—This methodology involves the predetermination of a bill mix by a person. This method requires knowing the exact transaction amount and is typically used for transaction types such as bill breaks. For instance, a bill mix may be preset for a bill break of each of the following bills: $100.00, $50.00, $20.00, $10.00, and $5.00. Alternatively, a predetermined bill mix may be pre-assigned by a person to every possible transaction dispense amount for other transaction types which may be burdensome if there are numerous possible transaction amounts for a given cash dispenser.
   Less commonly used logics for bill mix determination include:
(3) “Maximum Note” Method—This methodology is also known as “maximum bill mix” or “minimum denomination” and the calculation is based on the largest number of notes possible to fulfill the transaction. For example, if a transaction request is comprised of a $100.00 dispense amount and the cash dispenser carries a minimum denomination of $5.00 bills, then twenty $5.00 bills would be dispensed pursuant to the maximum-note methodology. Accordingly, bills are dispensed using the smallest possible denomination(s) contained in the cash dispenser's inventory to maximize the total number of dispensed bills.
(4) “Equalize Pick” Method—This methodology is also known as the “uniform emptying method” and it equalizes the wear and tear on the bill-carrying cassettes in a cash dispenser. For example, if two $100.00 dispense requests are made, one request may be fulfilled with cassette no. 1 to dispense one $100.00 bill, and the second request may be fulfilled with cassette no. 2 to dispense five $20.00 bills. Therefore, the individual cassettes are emptied with substantially equal probabilities.
(5) “Maximum Inventory” Method—This methodology attempts to equalize inventory level of bill denominations in the cash dispenser.

The above methods primarily consider inventory levels in calculating bill mix. In some cases, considering inventory level may be ideal in preventing depletion of bills to thereby allow the cash dispenser to perform more transactions. For instance, the least note method dispenses the least possible quantity of bills, and the maximum inventory equalizes bill denomination inventory; and both methods may result in the preservation of overall inventory and the ability to conduct more transactions. Dispensing a lower quantity of bills may also decrease time per transaction, increase dispense rate, and thus increase the cash dispenser's efficiency. Methods such as the equalize pick method may prolong the overall life of a cash dispenser.

However, the above-listed bill mix determination methods have a number of limitations and disadvantages since such methods consider criteria that are not relevant to: (i) the needs of the location or business where the cash dispenser or kiosk is located and (ii) the needs of the end user (“patron”) of the cash dispenser or kiosk. Therefore, the current bill mix determining methods provide bill mixes that are not ideal to both the cash dispenser/kiosk location and the patron. For instance, if a kiosk is located at a gentlemen's club, nightclub, bar, or other location where tipping is customary, a patron will not want a small quantity of high denomination bills. On the other hand, if a kiosk is located near a high-end retail establishment such as a jewelry store or designer boutique, a patron will not want a large quantity of low denomination bills.

The above-mentioned bill mix determination methods fail to take into account a variety of criteria that are relevant to the location or business where the cash dispenser or kiosk is located and the patron's needs. For example, a casino establishment may want to promote $5.00 bill dispense during bill break transactions to promote game play, while a gentleman club may want to promote $1.00 bill dispense during ATM withdrawals to encourage tipping. Furthermore, the current bill mix determination methods do not allow the dispensing of variable bill mixes. Current bill mix determinations and/or bill mix methodologies employed to determine bill mix are usually fixed in a given kiosk. For example, an ATM may dispense only $20.00 bills for all withdrawals, a bill break kiosk may offer only a predetermined bill mix for each bill denomination inserted in the kiosk, and a voucher redemption kiosk may only dispense bills pursuant to the least note methodology. However, a location or business may want to promote a specific bill mix dispense during certain days of the week (e.g., weekends) and/or during a specific time of day (e.g., happy hour) to complement and stimulate business activity during a particular day and/or time. In addition, a location or business may want to dispense a specific bill mix depending on other criteria such as patron information (e.g., player rating obtained from casino player tracking systems or patron data obtained from retail rewards programs), which are not considered by current bill mix determination methods.

Accordingly, there is a need in the art for a method and system that considers criteria that are relevant to both (i) the location or business where the cash dispenser or kiosk is located and (ii) the patron's needs. There is therefore a need in the art for a method and system that considers other types of factors that are not considered by current bill mix determination methods. A method and system that address the above-mentioned drawbacks in the art would not only provide a more suitable bill mix for both the location or business where the cash dispenser or kiosk is located and for the patron, but would increase business by encouraging the patron to spend if the patron has the appropriate bill denominations for the business's goods or services, provide convenience to the patron, prevent the patron from leaving the location/business to obtain suitable bill denominations, increase cash dispense transactions from the kiosk/cash dispenser which would generate more transaction fees, and would thus be more profitable for kiosk operators/providers and for the location or business where the cash dispenser or kiosk is located. Other advantages of the present invention will be apparent to one of ordinary skill in the art in light of the ensuing description of the present invention.

### SUMMARY

The present invention is directed to a method and system for determining a bill mix in an electronic cash dispenser that considers criteria that are relevant to both (i) the location or business where the cash dispenser or kiosk is located and (ii) the patron's needs. The criteria considered in the method and system of the present invention is comprised of factors that are not considered by current bill mix determination methods. Additionally, the method and system of the present invention allows for variable bill mixes depending on the various criteria evaluated.

The method of determining a bill mix of the present invention allows a location or business to customize dispense bill mix based on its needs. The criteria evaluated may include one or more of the following: day of the transaction, time of the transaction, transaction type, transaction amount, inventory level, patron information, patron preference, among other criteria; and the location or business may prioritize the criteria evaluated. Moreover, the payout utilizes “include at least” methodology or a “minimum definition” which defines the minimum number of notes for each denomination to include in the bill mix. If a remainder exists after the minimum definition is applied to the transaction amount, a remainder definition may then be used to calculate the remainder bill mix based on a customized or existing bill mix methodologies. For example, the remainder could be calculated using the “least note” methodology. In one embodiment of the invention, upon execution, the system of the present invention evaluates at least one criterion pursuant to the default profile based on the set priorities. If the evaluated criterion exists, the system is referred to an additional profile for evaluation. The evaluation and profile reference continues until no further reference is possible. A dispense definition for the currently evaluated profile is then used for the bill mix determination wherein the dispense definition is comprised of (i) an “include at least” definition or a “minimum definition” and (ii) a remainder definition that calculates the remainder bill mix (after the minimum definition is applied to the dispense amount) based on a customized or existing bill mix methodology.

To achieve the foregoing and in accordance with the purposes of the present invention, the present invention is directed to a method for determining a bill mix in an electronic cash dispenser comprising: (a) receiving a transaction request comprised of a transaction type and a dispense amount; (b) evaluating the transaction type; (c) evaluating the dispense amount; and (d) determining the bill mix according to a dispense definition based on a plurality of criteria including transaction type and dispense amount. The method may further include evaluating one or more of the following criteria: day of the transaction request, time of the transaction request, patron information such as player tracking data, and bill inventory level in the electronic cash dispenser. The method may also include receiving patron preference input wherein the patron inputs his or her bill mix preference and/or selects from multiple bill mix options. The dispense definition may include a minimum definition that defines a minimum quantity for each bill denomination to include in the bill mix. If a remainder exists after the minimum definition is applied to the dispense amount, the dispense definition may further include a remainder definition that calculates a remainder bill mix based on a customized or a current bill mix determination method. For instance, in one version of the invention, the remainder bill mix is calculated using least note methodology.

In an additional embodiment of the present invention, a method for determining a bill mix in an electronic cash dispenser comprises: (a) receiving a transaction request comprised of a transaction type and a dispense amount and (b) evaluating a first priority criterion according to a default profile that includes a first evaluation procedure for the first priority criterion and a default dispense definition. The first evaluation procedure comprises: (i) determining the bill mix pursuant to an “additional profile” for a predetermined category if the first priority criterion belongs to the predetermined category and (ii) continuing the bill mix determination pursuant to the default profile if the first priority criterion does not belong to the predetermined category. The default profile may further include a second evaluation procedure for a lower priority criterion. The second evaluation procedure may comprise: (i) determining the bill mix pursuant to a “further profile” for a predetermined value if the lower priority criterion is of the predetermined value, and (ii) continuing the bill mix determination pursuant to the default profile if the lower priority criterion is not of the predetermined value. In such versions of the invention, the first priority criterion may be the transaction type and the lower priority criterion may be the dispense amount. In alternate versions of the invention, the “additional profile” (which is used to determine bill mix if the first priority criterion belongs to the predetermined category) may include a second evaluation procedure for a lower priority criterion. In such versions of the invention, the first priority criterion may be the day of the transaction request and the lower priority criterion may be the time of the transaction request. In the above-described embodiment of the invention, the present invention may include: a plurality of “additional profiles” (which are used to determine bill mix if the first priority criterion belongs to one of multiple predetermined categories) and a plurality of “further profiles” (which are used to determine bill mix if the lower priority criterion is one of multiple predetermined values).

Furthermore, the default dispense definition includes a minimum definition that defines a minimum quantity for each bill denomination to include in the bill mix. If a remainder exists after the minimum definition is applied to the dispense amount, the dispense definition may further include a remainder definition that calculates a remainder bill mix based on a customized or a current bill mix determination method. For example, the remainder bill mix may be calculated using least note methodology. Similarly, the “additional profiles” (which are used to determine bill mix if the first priority criterion belongs to the predetermined category) and the “further profiles” (which are used to determine bill mix if the lower priority criterion is of a predetermined value) may each include a respective dispense definition that includes: (i) a minimum definition that defines a minimum quantity for each bill denomination to include in the bill mix and (ii) a remainder definition that calculates a remainder bill mix based on a customized or a current bill mix determination method such as the least note methodology (if a remainder exists after the minimum definition is applied to the dispense amount).

In a further embodiment of the present invention, a method for determining a bill mix in an electronic cash dispenser comprises: (a) identifying a plurality of criteria to potentially be evaluated for the bill mix determination, (b) prioritizing the plurality of criteria comprised of designating a first priority criterion, (c) receiving a transaction request comprised of a transaction type and a dispense amount wherein the plurality of criteria includes the transaction type and the dispense amount; (d) evaluating the first priority criterion; (e) evaluating the dispense amount; and (f) determining the bill mix. In one version of the invention, the first priority criterion is the transaction type. In another version, the plurality of criteria further includes day of the transaction request, and the first priority criterion is the day of the transaction request. The plurality of criteria may include one or more of the following criteria: day of the transaction request, time of the transaction request, and patron information in various embodiments of the invention. Depending on the evaluation outcome of the first priority criterion, all, some or none of the other criteria may be evaluated.

The above description sets forth a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects, and advantages of the present invention will become apparent from the following description of the invention, taken in conjunction with the accompanying drawings, which illustrate, by way of example, various features of embodiments of the invention.

### BRIEF DESCRIPTION OF THE DRAWINGS

FIG. 1 depicts a block diagram illustrating a method for determining a bill mix in accordance with an embodiment of the present invention.

FIG. 2 depicts a block diagram illustrating a method for determining a bill mix in accordance with an embodiment of the present invention.

FIG. 3 depicts a block diagram illustrating a method for determining a bill mix in accordance with an embodiment of the present invention.

FIG. 4 depicts a block diagram illustrating a method for determining a bill mix in accordance with an embodiment of the present invention.

FIG. 5 depicts a block diagram illustrating a method for determining a bill mix in accordance with an embodiment of the present invention.

FIG. 6 depicts a flowchart illustrating a method for determining a bill mix in accordance with an embodiment of the present invention.

FIG. 7 depicts a block diagram illustrating a method for determining a bill mix in accordance with an embodiment of the present invention.

FIG. 8 depicts a flowchart illustrating a method for determining a bill mix in accordance with an embodiment of the present invention.

FIG. 9 depicts a flowchart illustrating a method for determining a bill mix in accordance with an embodiment of the present invention.

FIG. 10 depicts a flowchart illustrating a method for determining a bill mix in accordance with an embodiment of the present invention.

FIG. 11 depicts a flowchart illustrating a method for determining a bill mix in accordance with an embodiment of the present invention.

### DESCRIPTION OF THE INVENTION

In the following description of embodiments of the invention, reference is made to the accompanying drawings, which form a part of this application. The drawings show, by way of illustration, certain embodiments in which the invention may be practiced. It is to be understood that other embodiments may be utilized and modifications may be made without departing from the scope of the present invention. Also, it is to be understood that the phraseology and terminology employed herein are for the purpose of description and should not be regarded as limiting.

The order in which the actions are presented below is not limited to any particular order and does not necessarily imply that they have to be performed in the order presented. It will be understood by those of ordinary skill in the art that the order of these actions can be rearranged and performed in any suitable manner. It further will be understood by those of ordinary skill in the art that some actions may be omitted, added, modified and/or consolidated and still fall within the spirit of the invention.

### Method for Determining a Bill Mix

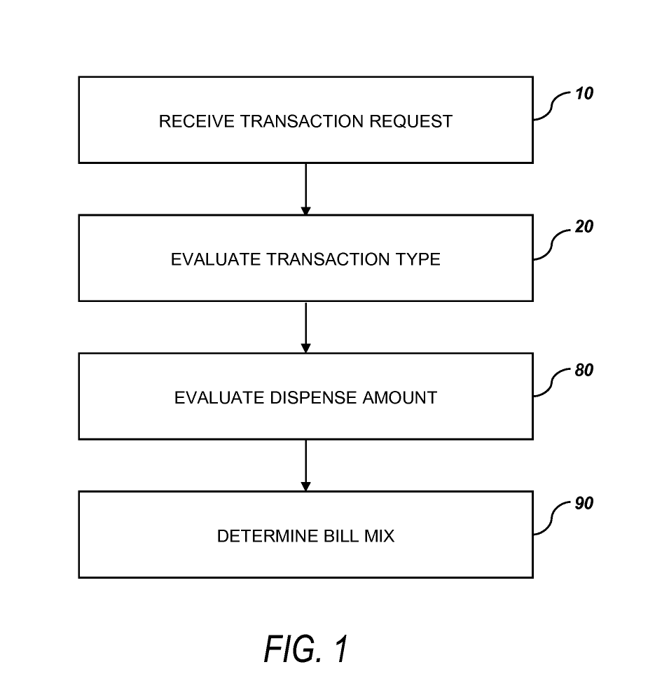

FIG. 1 depicts a block diagram illustrating a method for determining a bill mix in accordance with an embodiment of the present invention. In general, a computerized system, which is implemented in a cash-dispensing kiosk or a cashier-assisted cash dispenser, receives a transaction request (action 10); evaluates the transaction type (action 20); evaluates the dispense amount (action 80); and determines the bill mix (action 90).

Depending on the particular kiosk or cash dispenser and the type of transaction, the transaction request may be initiated by the patron's ATM card, debit card, credit card, player card, rewards card, a form of government issued identification such as a driver's license, an identifying number (e.g., social security number, driver's license number, player card number, house account number, rewards account number), biometric data such as a fingerprint, or any other form of identification that can be used to access a particular account that is tied to the specific cash dispense request. For bill break and currency exchange transactions, the transaction request is initiated by inserting the currency to be exchanged or converted into the kiosk.

The transaction request is comprised of the transaction type and a dispense amount. The transaction type may be comprised of a cash withdrawal from a bank account, a credit card cash advance, check cashing, bill break, exchange of foreign currency, or voucher redemption, among other transaction types. Furthermore, the transaction type may be comprised of a bill payment, the rental of goods, or the purchase of tickets, goods, or services, and the transaction type may involve dispensing cash change from a payment and/or dispensing cash back from a debit card transaction. The patron may designate the specific transaction type in kiosks that perform multiple types of cash dispense functions, or the kiosk may only permit one type of transaction (e.g., voucher redemption or bill break) in which case the patron does not need to designate the transaction type. The dispense amount may be inputted by the patron when initiating the transaction request, or in transaction types such as bill break or currency exchange, the dispense amount is the value of the currency inserted into the kiosk.

For example, a casino patron may wish to break a $100.00 bill by using a kiosk that performs both bill break and voucher redemption functions. Referring to FIG. 1, the patron initiates the transaction request by inserting the $100.00 into the kiosk, and the kiosk receives the transaction request (action 10). The transaction request is comprised of a bill break transaction type and a dispense amount of $100.00. The kiosk then evaluates the transaction type (action 20). In this particular embodiment, bill break transactions result in a different bill mix than voucher redemption transactions. For instance, the casino may have configured bill break transactions to dispense more bills of smaller denominations to encourage game play of nearby gaming machines and low minimum bet tables, whereas a voucher redemption transaction of the same dispense amount is configured to dispense fewer bills of higher denominations. The kiosk then evaluates the dispense amount (action 80) and determines the bill mix (action 90). The bill mix will of course differ for varying dispense amounts, but the casino may have also configured certain bill mixes to be dispensed for certain dispense amount ranges.

### Types of Criteria

The method of determining a bill mix of the present invention allows a location or business where a cash dispenser or kiosk is located to customize dispense bill mix based on its needs and its patron's needs. The criteria evaluated may include one or more of the following: day of the transaction request, time of the transaction request, transaction type, dispense amount, inventory level, patron information, and patron preference in addition to various other criteria.

### Day and Time of Transaction Request

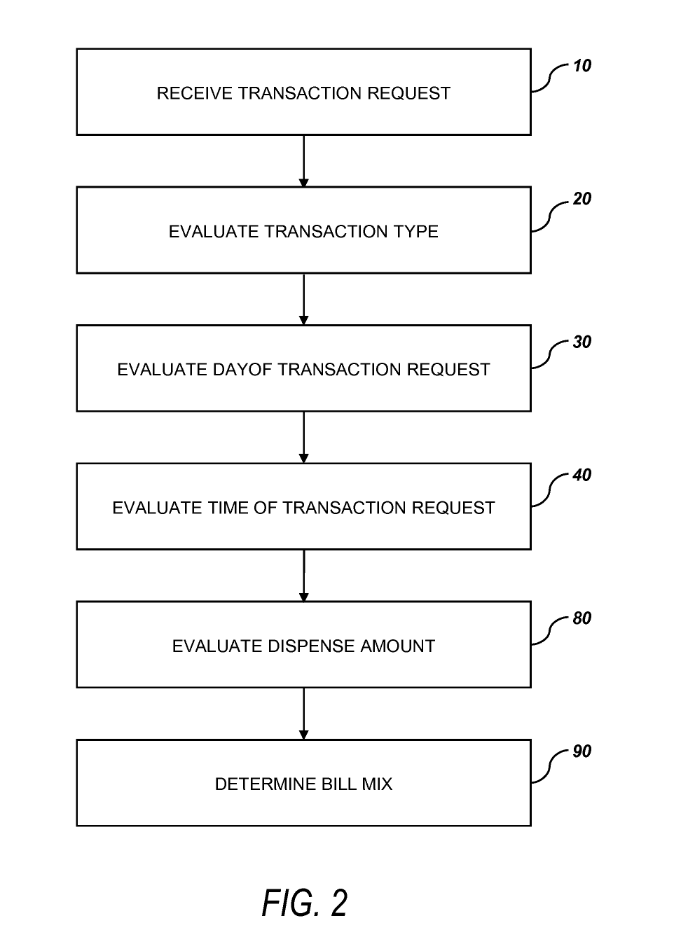

For instance, one embodiment of the invention evaluates day of the transaction request and the time of the transaction request to determine a bill mix. As depicted in FIG. 2, a method for determining a bill mix in an electronic cash dispenser is comprised of: receiving a transaction request (action 10); evaluating the transaction type (action 20); evaluating the day of the transaction request (action 30); evaluating the time of the transaction request (action 40); evaluating the dispense amount (action 80); and determining the bill mix (action 90).

A particular business such as a nightclub, bar, or gentlemen's club may want to dispense specific bill mixes on certain days of the week (e.g., weekends) and/or at certain times of the day (e.g., during happy hour or after midnight) to stimulate business activity. Evaluation of day of the transaction request (action 30) may involve evaluating the day of the week (i.e., Monday, Tuesday, Wednesday, Thursday, Friday, Saturday, or Sunday), whether the day is a weekday or weekend, the actual date or day of the year (which will account for certain holidays), or day of the month (e.g., 1^{st} day of the month or 15^{th} day of the month). Evaluation of the time of the transaction request (action 40) may involve evaluating specific time ranges (e.g., 5:00 p.m. to 7:00 p.m. for happy hour at a bar or 12:00 p.m. to 5:00 p.m. for day-shift two-for-one dance specials at a gentlemen's club). Accordingly, a business may configure particular bill mixes to compliment business activity that occur on certain days and at certain times of the day. For instance, a bar may configure its ATM to dispense bill mixes comprised of $5.00 and $1.00 bills during weekday happy hours to cover $5.00 drinks specials and $1.00 for tipping, while a gentlemen's club may configure its ATM to dispense bill mixes comprised of $10.00 and $1.00 bills during Friday afternoon two-for-one dance specials to cover $10.00 lap dances and $1.00 stage tipping.

### Patron Information

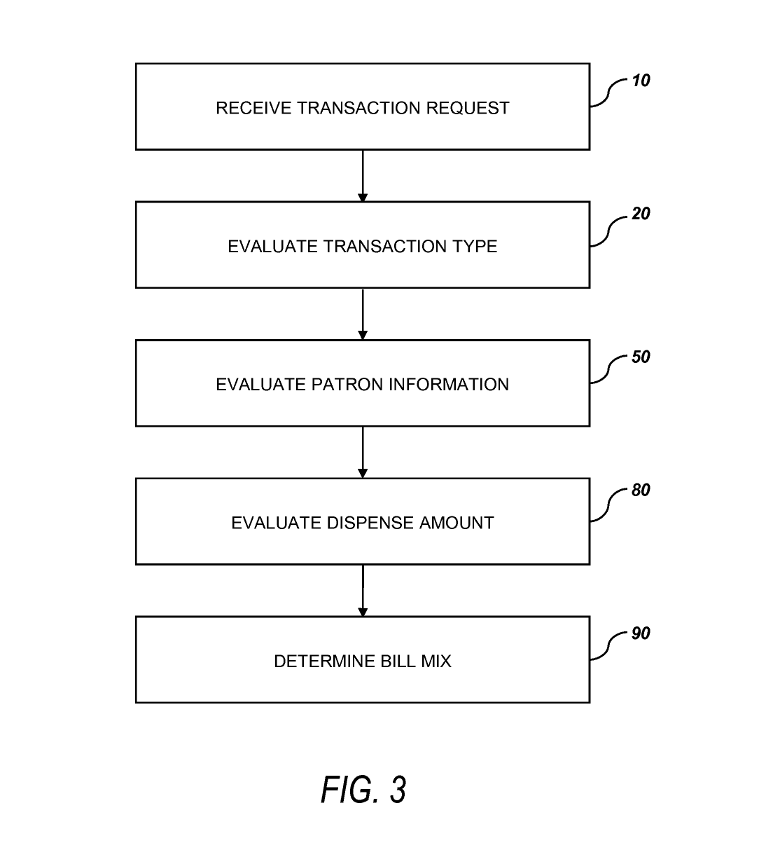

Other embodiments of the invention may evaluate patron information to determine bill mix. As shown in FIG. 3, a method for determining a bill mix in an electronic cash dispenser is comprised of: receiving a transaction request (action 10); evaluating the transaction type (action 20); evaluating patron information (action 50); evaluating the dispense amount (action 80); and determining the bill mix (action 90).

Such patron information may be retrieved via the patron identifier used to initiate the transaction request such as the patron's ATM card, debit card, credit card, player card, rewards card, government issued identification, an identifying number (e.g., social security number, driver's license number, player card number, house account number, rewards account number), etc. The patron information evaluated may be comprised of data collected from retail rewards programs that track the patron's expenditures and shopping habits, casino player tracking systems that track a patron's gaming activity, and other patron tracking systems that track activity and expenditures that may be relevant to a particular location or business. Other patron information that may be evaluated may include the patron's transaction request history, gender, age, city of residence, and demographic data which businesses may find useful in stimulating certain types of business activity or increasing sales of certain types of goods.

For example, a casino may wish to evaluate player tracking data collected by the casino's player tracking system to determine a bill mix to dispense for a particular patron. The player tracking system tracks player gaming activity that occurs within a gaming establishment or within a group of affiliated or commonly owned gaming establishments. The player tracking system tracks gaming activity at slot machines, video gaming machines (e.g., video poker machines, video keno machines, etc.), table games, and at the race and sports book. The player tracking system collects data via player cards or reward cards that are inserted into the card reader of gaming machines or provided to the host at table games. Player tracking data may comprise of the player's coin-in activity (bets), coin-out activity (payouts), length of total game play, length of membership, type of games played, and various types of other player-related data. The player tracking data to be considered to determine a bill mix to dispense to a patron may comprise of: (i) player rating determined by the player tracking system (e.g., Gold, Silver or Bronze tiers or defined in a numeric form generally referring to the player's coin-in or coin-out over a period of time) and/or (ii) at least one type of player tracking data such as the player's coin-in and/or coin-out activity in a given time.

In one scenario, a casino patron may want to withdraw $400.00 from his bank account using an ATM located within the casino's property. Referring to FIG. 3, the patron initiates the transaction request using his ATM card and/or player card, and the ATM thus receives a transaction request (action 10). The transaction request is comprised of the transaction type, which is a withdrawal from the patron's bank account, and a dispense amount of $400.00. The ATM then evaluates the transaction type (action 20); evaluates the patron information (action 50); evaluates the dispense amount (action 80); and determines the bill mix (action 90). In this particular embodiment, the patron information evaluated is the player rating as defined by the casino's player tracking system. The patron's player rating may be retrieved via an electronic connection to the casino's player tracking system or to a database containing player tracking data. The casino may preconfigure the ATM to dispense (i) a bill mix comprised of higher denominations for patron's with high player ratings to encourage game play with higher minimum bets and (ii) a bill mix comprised of lower denominations for patron's with low player ratings to encourage game play with lower minimum bets. For example, for a $400.00 withdrawal, a patron with a high player rating may receive a bill mix of two $100.00 bills and four $50.00 bills, whereas a patron with a low player rating may receive a bill mix of ten $20.00 bills and twenty $10.00 bills.

In a similar example, a casino patron may wish to cash a check, cash out chips, redeem a voucher, or perform a bill break at the “casino cage” or “cashier's cage” located within the casino. Still referring to FIG. 3, the patron provides a patron identifier such as a player's card, form of identification, or an identifying number (e.g., social security number, driver's license number, player card number, house account number), to the cashier. The cashier inputs the player identifier by scanning or swiping the player identifier card and/or by inputting the patron's identifying information into the casino's computerized system that is handling the transaction request so the transaction request is thereby received by the computerized system (action 10). The system then evaluates the transaction type (action 20); evaluates patron information (action 50); and evaluates the dispense amount (action 80), the order of which may vary depending on the embodiment of the invention. In this example, the casino may have configured the system to automatically dispense different bill mixes depending on whether the transaction type is check cashing, chip cashing, voucher redemption, or bill break. The patron information evaluated is the player rating as defined by the casino's player tracking system. The patron's player rating may be retrieved via an electronic connection to the casino's player tracking system or to a database containing player tracking data. The casino may have configured the system to automatically dispense different bill mixes depending on the patron's player rating. After the transaction type, patron information, and dispense amount are evaluated (actions 20, 50, and 80), the system then determines the bill mix to be dispensed from the electronic cash dispenser (action 90). In certain instances, some of the casino's preconfigured settings may be overridden or modified by the cashier (e.g., the cashier may revise a preset default bill mix pursuant to the patron's request for a specific bill mix).

### Patron Preference

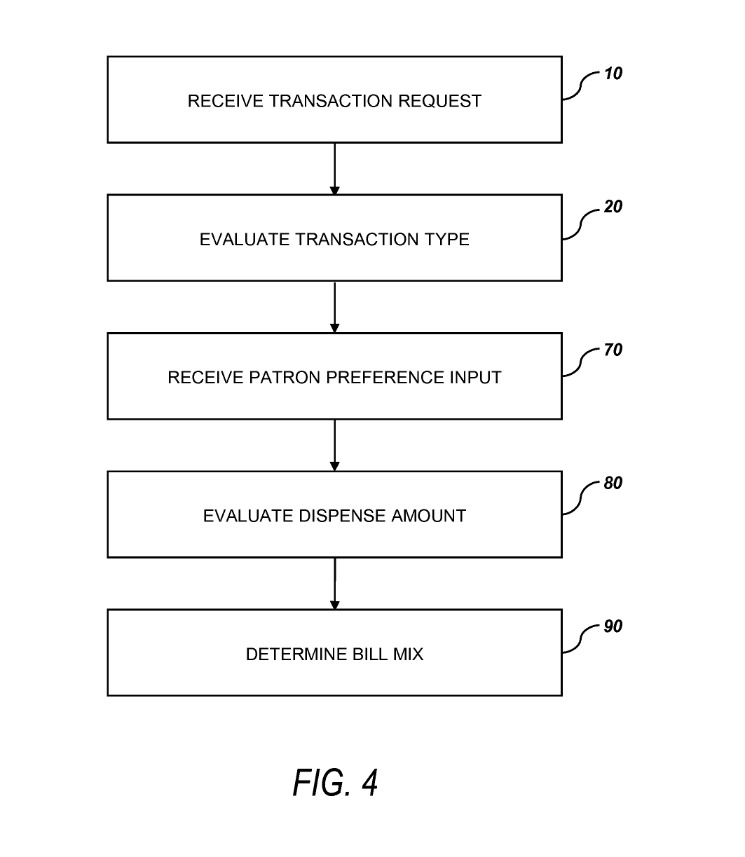

Some embodiments of the invention may also consider patron preference to determine a bill mix. As shown in FIG. 4, a method for determining a bill mix in an electronic cash dispenser is comprised of: receiving a transaction request (action 10); evaluating the transaction type (action 20); receiving patron preference input (action 70); evaluating the dispense amount (action 80); and determining the bill mix (action 90).

In such versions of the invention, the business may still preconfigure the bill mix in accordance with its needs and its patron's needs. However, the business may want to offer the patron options as to which preconfigured bill mix he or she prefers. For example, a particular business may have configured its kiosks to dispense a minimum of two $10.00 bills for every cash withdrawal. If the patron is withdrawing $40.00, the kiosk may allow the patron to select a bill mix comprised of either: (a) two $10.00 bills and one $20.00 bill, (b) two $10.00 bills and four $5.00 bills, or (c) four $10.00 bills, all of which contain the minimum two $10.00 bill requirement as configured by the business. In another version of the invention, the kiosk calculates the bill mix automatically according to the business's preset configurations, and the patron may then modify the bill mix so long as the business's preset minimum bill mix is included in the bill mix (i.e., the patron may modify the bill mix of the remainder amount, which is the amount remaining after the minimum bill mix is applied to the original dispense amount). Yet, in another version of the invention, the kiosk may allow the patron to choose the bill mix methodology. For instance, a business may configure a kiosk to offer a predetermined set of bill mix methodologies that dispense bill mixes according to the business's preferences. Thus, if a patron is initiating a cash withdrawal, the kiosk may allow the patron to choose a methodology such as: minimum number of bills or largest denominations possible; maximum number of bills or smallest denominations possible; or maximum $20.00 bills available.

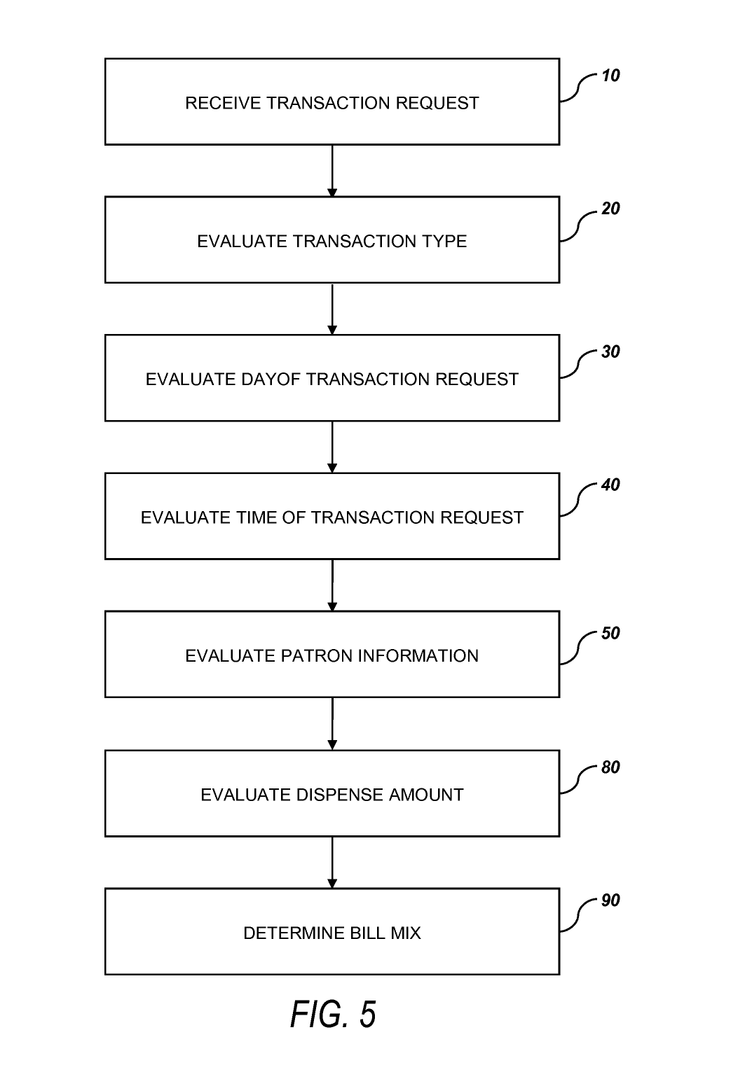

The method of determining a bill mix of the present invention allows a location or business where a cash dispenser or kiosk is located to customize dispensed bill mix based on its needs and its patron's needs; and therefore a business or location may select any combination of criteria to evaluate for bill mix determination. For instance, one embodiment of the invention evaluates day of the transaction request, time of the transaction request, transaction type, dispense amount, and patron information. As depicted in FIG. 5, a method for determining a bill mix in an electronic cash dispenser is comprised of: receiving a transaction request (action 10); evaluating the transaction type (action 20); evaluating the day of the transaction request (action 30); evaluating the time of the transaction request (action 40); evaluating patron information (action 50); evaluating the dispense amount (action 80); and determining the bill mix (action 90). Of course additional criteria and various combinations of criteria may be evaluated to determine a bill mix in accordance with the present invention.

### Dispense Definition

The present invention determines bill mix by evaluating various criteria that are not evaluated by current bill mix methodologies and by applying a dispense definition (as defined by the location or business where the cash dispenser or kiosk is located) that is based on the criteria evaluated. The dispense definition may be a unique predetermined bill mix for each possible dispense amount. However, in many of the embodiments of the present invention, the dispense definition is comprised of an “include at least” definition or a “minimum definition” which defines the minimum number of notes for each denomination to include in the bill mix. If a remainder exists after the minimum definition is applied to the dispense amount, the dispense definition may further comprise a remainder definition that calculates the remainder bill mix based on a customized or existing bill mix methodology such as a “least note” methodology.

For example, a bar may set a minimum definition comprised of two $5.00 bills and five $1.00 bills to encourage drink purchases and tipping for all cash dispense transactions that occur during happy hour. If a patron is making a $30.00 withdrawal at the bar's kiosk during happy hour, the patron will receive a bill mix of at least two $5.00 bills and five $1.00 bills pursuant to the minimum definition, leaving a remainder of $15.00. The bill mix for the remainder may then be calculated using a customized methodology set by the bar or by using an existing bill mix methodology. For instance, the remainder definition may use the least note methodology to calculate the remainder bill mix for the remaining $15.00, which would dispense one $10.00 bill and one $5.00 bill for the remainder, or the remainder definition may use the maximum note methodology to calculate the remainder bill mix for the remaining $15.00, which would dispense fifteen $1.00 bills.

Exemplified in the tables below are sample bill mixes determined by dispense definitions comprised of: (i) an “include at least” definition or a “minimum definition” which defines the minimum number of notes for each denomination to include in the bill mix and (ii) a remainder definition calculates the remainder bill mix based on a least note methodology. For example, a minimum definition may comprise of either: (a) one $20.00 bill, one $10.00 bill, one $5.00 bill, and one $1.00 bill (“Minimum Definition A”); (b) six $20.00 bills (“Minimum Definition B”); or (c) one $10.00 bill and two $5.00 bills (“Minimum Definition C”) as represented below in TABLES 1, 2, and 3, respectively.

TABLE 1
Minimum Definition A

| Bill Denomination | Minimum Number of Bills |
|---|---|
| $20.00 | 1 |
| $10.00 | 1 |
| $5.00 | 1 |
| $1.00 | 1 |

TABLE 2
Minimum Definition B

| Bill Denomination | Minimum Number of Bills |
|---|---|
| $20.00 | 6 |
| $10.00 | 0 |
| $5.00 | 0 |
| $1.00 | 0 |

TABLE 3
Minimum Definition C

| Bill Denomination | Minimum Number of Bills |
|---|---|
| $20.00 | 0 |
| $10.00 | 1 |
| $5.00 | 2 |
| $1.00 | 0 |

When determining a bill mix for a certain dispense amount, the corresponding minimum definition would first be applied to the dispense amount. If a remainder exists after the minimum definition is applied to the dispense amount, then a remainder definition would be applied to determine a bill mix for the remainder based on the least note methodology. For example, if applying Minimum Definition A for a dispense amount of $250.00 and then using a remainder definition based on the least note methodology, the following bill mix would be dispensed: two $100.00 bills, one $20.00 bill, two $10.00 bills, one $5.00 bill, and five $1.00 bills as shown in TABLE 4. This bill mix is derived from applying Minimum Definition A comprised of: one $20.00 bill, one $10.00 bill, one $5.00 bill, and one $1.00 bill to the dispense amount of $250.00 which results in a remainder of $214.00. The bill mix for the remaining $214.00 would then be calculated using the least note methodology, which would produce a remainder bill mix of two $100.00 bills, one $10.00 bill, and four $1.00 bills. Therefore, applying both the minimum bill mix definition and the remainder definition to the dispense amount produces an overall bill mix of: two $100.00 bills, one $20.00 bill, two $10.00 bills, one $5.00 bill, and five $1.00 bills.

The application of Minimum Definition A, Minimum Definition B, and Minimum Definition C to different dispense amounts are demonstrated below in TABLES 4, 5, and 6, respectively. TABLES 4, 5, and 6 each illustrate bill mixes for $250.00, $110.00, and $60.00 dispense amounts as indicated on the far left column of each table, and the bill mixes are designated by the number of bills designated in each bill denomination column.

The designated bill mixes are derived by (i) applying the corresponding minimum definition (i.e., Minimum Definition A, Minimum Definition B, or Minimum Definition C) to the dispense amount, and (ii) if a remainder exists after application of the minimum definition to the dispense amount, applying a remainder definition that calculates the remainder bill mix based on a least note methodology.

TABLE 4
Minimum Definition A and Least Note Remainder Definition

| | Number of | Number of | Number of | Number of | Number of |
|---|---|---|---|---|---|
| Dispense | $100.00 | $20.00 | $10.00 | $5.00 | $1.00 |
| Amount | Bills | Bills | Bills | Bills | Bills |
| $250.00 | 2 | 1 | 2 | 1 | 5 |
| $110.00 | 0 | 4 | 2 | 1 | 5 |
| $60.00 | 0 | 2 | 1 | 1 | 5 |

TABLE 5
Minimum Definition B and Least Note Remainder Definition

| | Number of | Number of | Number of | Number of | Number of |
|---|---|---|---|---|---|
| Dispense | $100.00 | $20.00 | $10.00 | $5.00 | $1.00 |
| Amount | Bills | Bills | Bills | Bills | Bills |
| $250.00 | 1 | 7 | 1 | 0 | 0 |
| $110.00 | 0 | 5 | 1 | 0 | 0 |
| $60.00 | 0 | 3 | 0 | 0 | 0 |

TABLE 6
Minimum Definition C and Least Note Remainder Definition

| | Number of | Number of | Number of | Number of | Number of |
|---|---|---|---|---|---|
| Dispense | $100.00 | $20.00 | $10.00 | $5.00 | $1.00 |
| Amount | Bills | Bills | Bills | Bills | Bills |
| $250.00 | 2 | 1 | 2 | 2 | 0 |
| $110.00 | 0 | 4 | 2 | 2 | 0 |
| $60.00 | 0 | 2 | 1 | 2 | 0 |

Accordingly, TABLES 1-3 above demonstrate possible minimum definitions, and TABLES 4-6 demonstrate the determination of the bill mix using a dispense definition comprised of a minimum definition and a remainder definition. Of course, other minimum definitions and remainder definitions are possible as they can be defined and customized by the location or business where the cash dispenser or kiosk is located to address the location or business's specific needs as well as the needs of their patrons.

### Prioritizing and Profiles

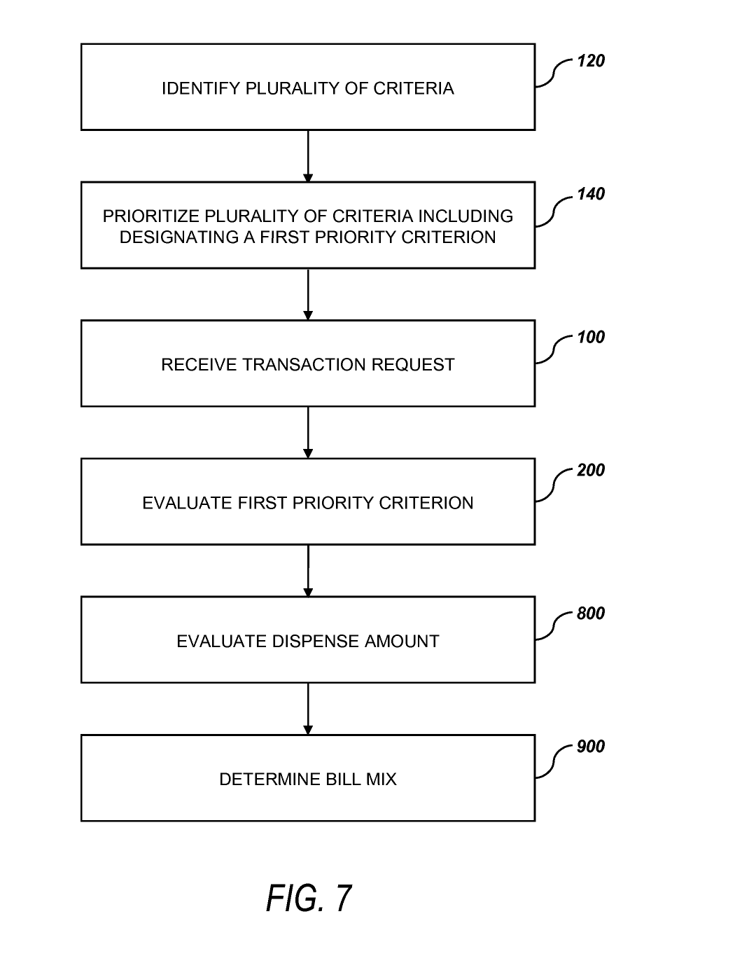

As depicted in FIG. 7, an embodiment of the present invention is directed to a method for determining a bill mix in an electronic cash dispenser and comprises: identifying a plurality of criteria (action 120); prioritizing the plurality of criteria including designating a first priority criterion (action 140); receiving a transaction request (action 100); evaluating the first priority criterion (action 200); evaluating the dispense amount; (action 800); and determining the bill mix (action 900).

The actions of identifying a plurality of criteria (action 120) and prioritizing the plurality which includes designating a first priority criterion (action 140) may be performed by the cash dispenser/kiosk provider (i.e., the independent entity that provides the cash dispenser or kiosk to a location or business where the cash dispenser or kiosk is located for patron use). However, in some embodiments of the invention, the location or business where the cash dispenser or kiosk is located may modify the bill mix configurations as desired or as needed. In such embodiments, the business would have access to the system of the present invention via an electronic connection to the bill mix system such as an Internet connection or a LAN (local area network) to enable instant or real-time modifications to the bill mix configurations. For instance, the method of the present invention may be configured such that day of the transaction and time of the transaction are the criteria to be evaluated to determine bill mix, with day being designated as the first priority criterion. If the business's kiosk was subject to excessive use during a large sporting event, the business may want to temporarily change the bill mix configuration such that inventory level is first priority criterion to avoid early depletion of currency and to allow more transactions. Thus, the business can identify a different set of criteria and designate a different first priority criterion, and the business would reconfigure the settings accordingly. In such embodiments of the invention, the business could later revert the settings back to its original configuration, or it can identify new criteria to evaluate and prioritize the criteria pursuant to its current needs.

In addition to selecting and identifying which types of criteria to potentially evaluate in determining the bill mix (action 120), the location or business where the cash dispenser or kiosk is located can prioritize the different types of criteria (action 140) such that the higher ranked and more important criteria affect the dispensed bill mix more than lower ranked criteria. Each type of criteria may be weighted by the location or business in accordance with its relative importance and impact on the business. By considering and evaluating the first priority criterion first and potentially evaluating the lower priority criteria depending on the evaluation outcome of the first priority criterion evaluation, the first priority criterion will ultimately have a larger influence on the bill mix. Accordingly, actions 120 and 140 are performed in accordance to the location or business's individual preferences, and by identifying the criteria to evaluate (action 120) and prioritizing said criteria (action 140), each location or business can customize the bill mix determination in accordance to its specific needs.

For instance, a nightclub is not likely to identify patron information such as player rating as a criterion to evaluate to determine a suitable bill mix unless the nightclub was located on a casino's property, was owned by the casino establishment, and/or offers gaming machines to its patrons. Thus, only criteria that are relevant to a location or business would be selected for the bill mix determination. Furthermore, criteria such as day and time of the transaction may be more important to a nightclub as opposed to patron information (e.g., rewards data relating to the patron's retail spending history), which would be more important to a retail store. Therefore, the ability to select the criteria and prioritize the criteria to be evaluated allows improved customization for a particular business or location to provide the most suitable bill mixes to its patrons.

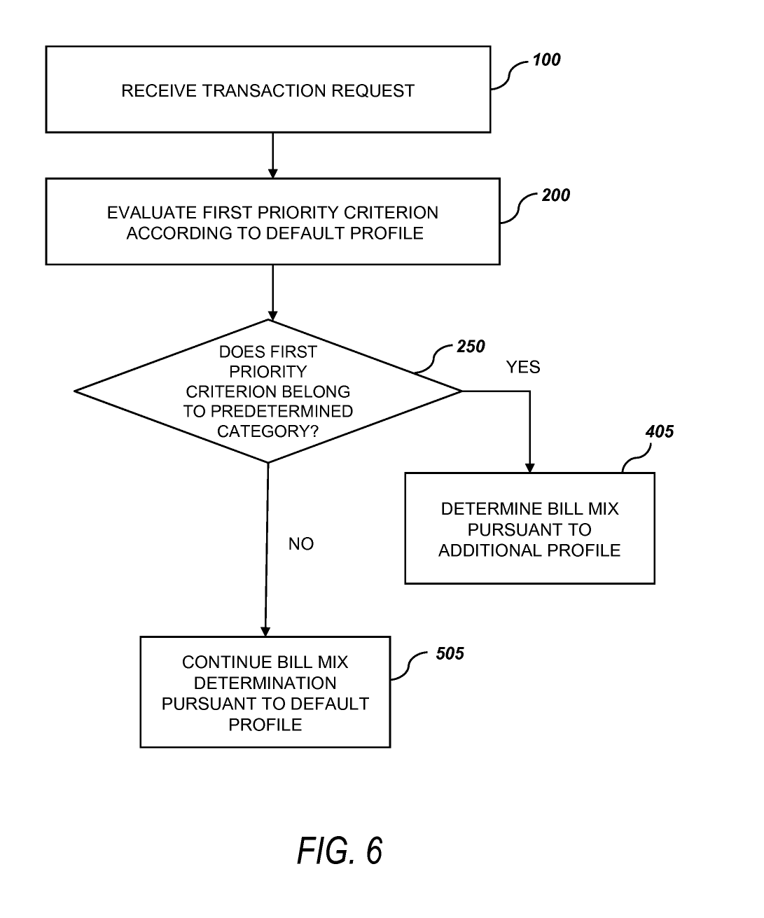

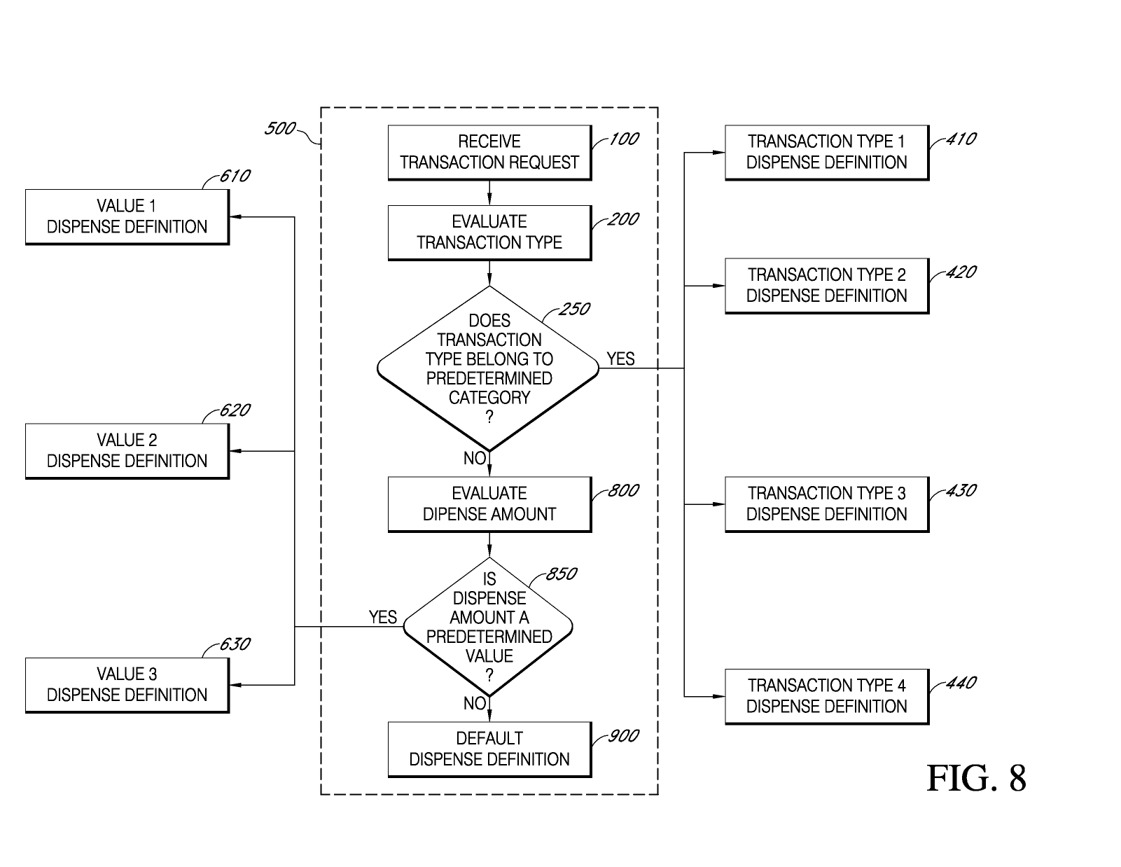

As discussed hereinbelow and as illustrated in the flowcharts shown in FIGS. 8-11, it is possible that a lower priority criterion will not be evaluated depending on the evaluation outcome of a higher priority criterion. Therefore, in some embodiments, not all criteria that are identified in action 120 will be evaluated to determine bill mix although the first priority criterion will be evaluated in the embodiments of the invention depicted in FIGS. 6 and 7.

FIG. 6 depicts another embodiment of the present invention directed to a method for determining a bill mix is comprised of: receiving a transaction request (action 100) and evaluating the first priority criterion according to a default profile (action 200). The default profile includes a first evaluation procedure for the first priority criterion, and this first evaluation procedure involves determining whether the first priority criterion belongs to a predetermined category (action 250). If the first priority criterion belongs to the predetermined category, then the first evaluation procedure comprises determining the bill mix pursuant to an additional profile (action 405). If the first priority criterion does not belong to the predetermined category, then the first evaluation procedure comprises continuing the bill mix determination pursuant to the default profile (action 505).

In one embodiment of the invention, the default profile may further include a second evaluation procedure to evaluate a lower priority criterion. FIG. 8 depicts an embodiment of the invention in which the first priority criterion is the transaction type and the lower priority criterion is the dispense amount. As seen in FIG. 8, the default profile 500 includes: (1) a first evaluation procedure comprised of (i) evaluating transaction type (action 200) and (ii) determining whether the transaction type belongs to a predetermined category (action 250); and (2) a second evaluation procedure comprised of (i) evaluating dispense amount (action 800) and (ii) determining whether the dispense amount is of a predetermined value (action 850).

Referring still to FIG. 8, a bill mix determination method includes: receiving the transaction request (action 100) wherein the transaction request is comprised of a transaction type and a dispense amount; evaluating the transaction type (action 200); and determining whether the transaction type belongs to a predetermined category (action 250). If the transaction type belongs to one of the predetermined categories comprised of transaction type 1, transaction type 2, transaction type 3, or transaction type 4, then the bill mix will be determined pursuant to profile 410, 420, 430, or 440, respectively. For example, in one version of the invention, transaction type 1, transaction type 2, transaction type 3, and transaction type 4 may be a cash withdrawal, credit card cash advance, bill break, and voucher redemption, respectively. Each profile 410, 420, 430, and 440 includes its respective dispense definition to determine bill mix. As discussed above, each dispense definition may include: (i) a “include at least” definition or a “minimum definition” which defines the minimum number of notes for each denomination to include in the bill mix and (ii) a remainder definition that is used to calculate the remainder bill mix after the minimum definition is applied to the dispense amount wherein the remainder definition is based on a customized or existing bill mix determination methodology.

Referring back to action 250 of FIG. 8, if the transaction type does not belong to one of the predetermined categories, the bill mix determination is continued pursuant to default profile 500 which then includes evaluating the dispense amount (action 800) and determining whether the dispense amount is of a predetermined value (action 850). If the dispense amount is of a predetermined value of either value 1, value 2, or value 3, then the bill mix will be determined pursuant to profile 610, 620, or 630, respectively. Value 1, value 2, and value 3 may each designate a dispense amount value range depending on the embodiment of the invention. Each profile 610, 620, and 630 includes its own respective dispense definition (comprised of a minimum definition and remainder definition) to determine the bill mix. Referring back to action 850, if the dispense amount is not of a predetermined value, then the bill mix is determined pursuant to the default dispense definition (action 900).

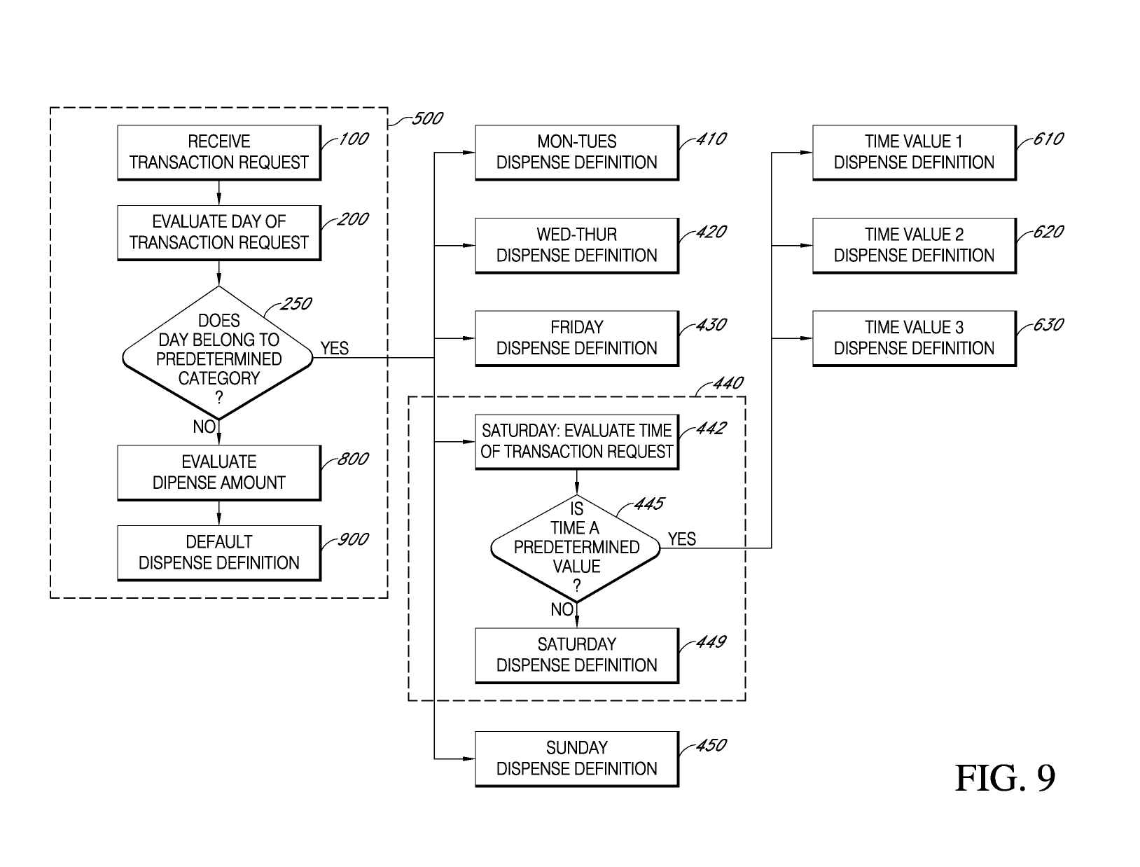

In an alternate embodiment of the invention, an additional profile may further include a second evaluation procedure to evaluate a lower priority criterion. FIG. 9 depicts an embodiment of the invention in which the first priority criterion is the day of the transaction request and a lower priority criterion is the time of the transaction request. As shown in FIG. 9, the default profile 500 includes a first evaluation procedure comprised of (i) evaluating day of the transaction request (action 200) and (ii) determining whether the day of the transaction request belongs to a predetermined category (action 250). Profile 440 is one of the additional profiles used to determine bill mix if the day of the transaction request belongs to a predetermined category, and profile 440 includes a second evaluation procedure comprised of (i) evaluating time of the transaction request (action 442) and (ii) determining whether the time of the transaction request is of a predetermined value (action 445).

As depicted in FIG. 9, a bill mix determination method includes: receiving the transaction request (action 100); evaluating the day of the transaction request (action 200); and determining whether the day of the transaction request belongs to a predetermined category (action 250). If the transaction type does not belong to one of the predetermined categories, then the bill mix determination is continued pursuant to default profile 500 which then includes: evaluating the dispense amount (action 800) and determining the bill mix pursuant to the default dispense definition (action 900).

Referring back to action 250 of FIG. 9, if the day of the transaction request belongs to one of the predetermined categories comprised of: (1) Monday-Tuesday, (2) Wednesday-Thursday, (3) Friday, (4) Saturday, or (5) Sunday, then the bill mix will be determined pursuant to profile 410, 420, 430, 440, or 450, respectively. Each profile 410, 420, 430, 440, and 450 includes its respective dispense definition to determine bill mix. As discussed above, each dispense definition may include (i) a “include at least” definition or a “minimum definition” which defines the minimum number of notes for each denomination to include in the bill mix and (ii) a remainder definition that is used to calculate the remainder bill mix (after the minimum definition is applied to the dispense amount) based on a customized or existing bill mix determination methodology. If day of the transaction request falls in either of the following categories: Monday-Tuesday, Wednesday-Thursday, Friday, or Sunday, the bill mix is then determined pursuant to the dispense definitions included in profiles 410, 420, 430, or 450, respectively.

Still referring to action 250 of FIG. 9, if the day of the transaction request is Saturday, then the bill mix is determined pursuant to profile 440, which includes a second evaluation procedure comprised of (i) evaluating time of the transaction request (action 442) and (ii) determining whether the time of the transaction request is of a predetermined value (action 445). If the time of the transaction request is of a predetermined value of either: time value 1, time value 2, or time value 3, then the bill mix will be determined pursuant to profile 610, 620, or 630, respectively, all of which includes its respective dispense definition to determine bill mix. Time value 1, time value 2, and time value 3 may each designate a time range. Referring back to action 445, if the time is not of a predetermined value comprised of time value 1, time value 2, or time value 3, then the bill mix is determined pursuant to the Saturday dispense definition (action 449).

In a further embodiment of the present invention, a plurality of additional profiles may each include a second evaluation procedure to evaluate a lower priority criterion.

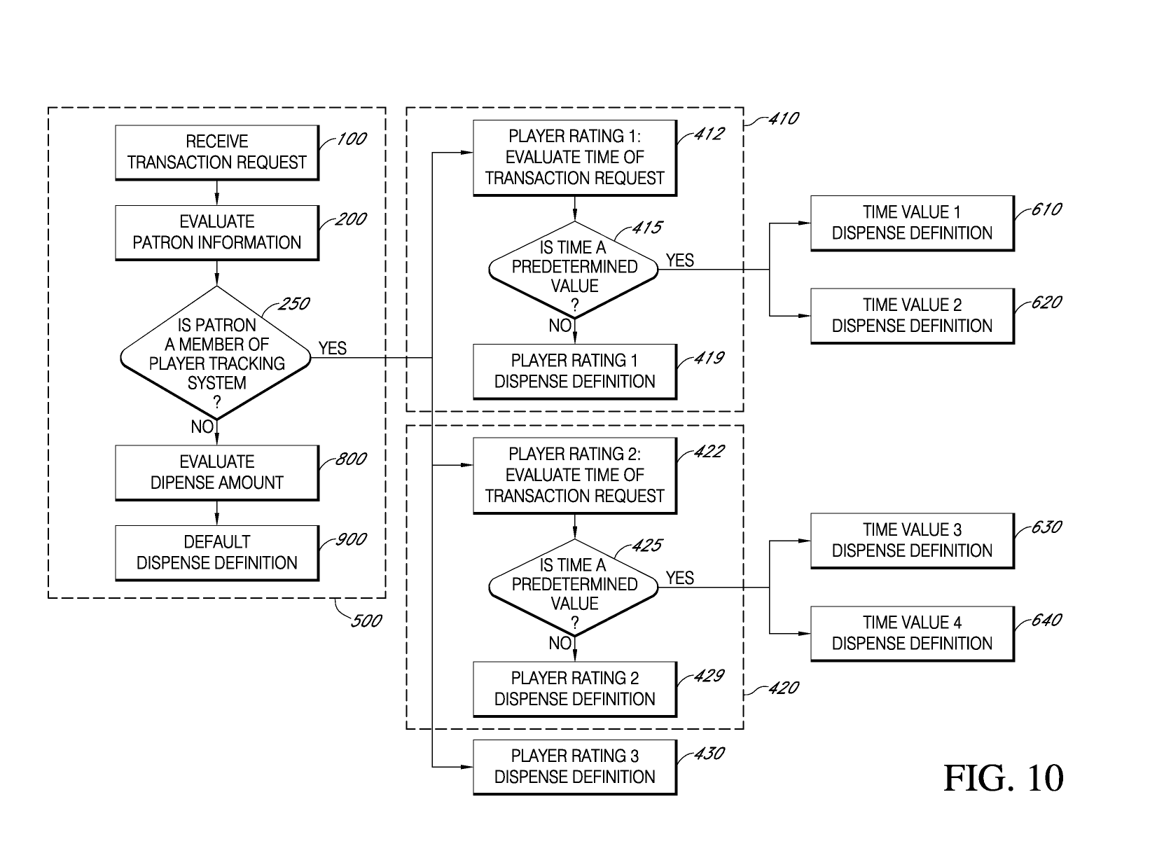

FIG. 10 illustrates an embodiment of the invention in which the first priority criterion is patron information and a lower priority criterion is the time of the transaction request. As shown in FIG. 10, the default profile 500 includes a first evaluation procedure comprised of (i) evaluating patron information (action 200) and (ii) determining whether the patron is a member of a player tracking system (action 250). Profile 410 is an additional profiles used to determine bill mix if the patron is a member of a player tracking system, and profile 410 includes a second evaluation procedure comprised of (i) evaluating time of the transaction request (action 412) and (ii) determining whether the time of the transaction request is of a predetermined value (action 415). Similarly, profile 420 also includes a second evaluation procedure comprised of (i) evaluating time of the transaction request (action 422) and (ii) determining whether the time of the transaction request is of a predetermined value (action 425).

As illustrated in FIG. 10, a bill mix determination method includes: receiving the transaction request (action 100); evaluating patron information (action 200); and determining whether the patron is a member of a player tracking system (action 250). If the patron is not a member of a player tracking system, then the bill mix determination is continued pursuant to default profile 500 which then includes: evaluating the dispense amount (action 800) and determining the bill mix pursuant to the default dispense definition (action 900).

Referring back to action 250 of FIG. 10, if the patron is a member of a player tracking system and has a rating of either: player rating 1, player rating 2, or player rating 3, then the bill mix will be determined pursuant to profile 410, 420, or 430, respectively. Each profile 410, 420, and 430 includes its respective dispense definition to determine bill mix. As mentioned above, each dispense definition may include (i) a “include at least” definition or a “minimum definition” which defines the minimum number of notes for each denomination to include in the bill mix and (ii) a remainder definition that is used to calculate the remainder bill mix after the minimum definition is applied to the dispense amount wherein the remainder definition is based on a customized or existing bill mix determination methodology. If the patron has a player rating 3, the bill mix is then determined pursuant to the player rating 3 dispense definition included in profile 430.

Still referring to action 250 of FIG. 10, if the patron has a player rating 1, the bill mix is then determined pursuant to profile 410, which also includes a second evaluation procedure comprised of (i) evaluating time of the transaction request (action 412) and (ii) determining whether the time of the transaction request is of a predetermined value (action 415). If the time of the transaction request is of a predetermined value of either time value 1 or time value 2, then the bill mix will be determined pursuant to profile 610 and 620, respectively, both of which includes a respective dispense definition to determine bill mix. Still referring to action 415, if the time of the transaction request is not of a predetermined value, then the bill mix is determined pursuant to player rating 1 dispense definition (action 419).

Referring back to action 250 of FIG. 10, if the patron has a player rating 2, the bill mix is then determined pursuant to profile 420, which also includes a second evaluation procedure comprised of (i) evaluating time of the transaction request (action 422) and (ii) determining whether the time of the transaction request is of a predetermined value (action 425). If the time of the transaction request is of a predetermined value comprised of time value 3 or time value 4, then the bill mix will be determined pursuant to profile 630 and 640, respectively, both of which includes a respective dispense definition to determine bill mix. Still referring to action 425, if the time of the transaction request is not of a predetermined value, then the bill mix is determined pursuant to player rating 2 dispense definition (action 429).

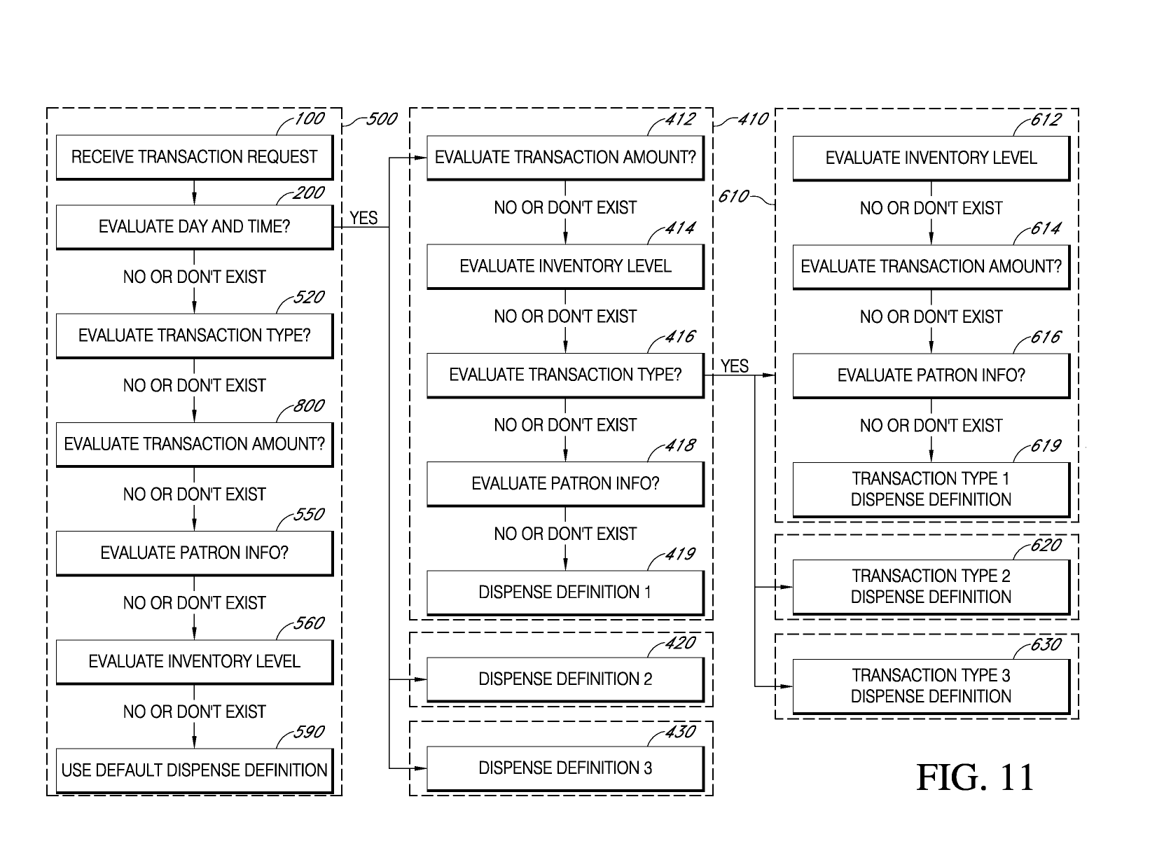

The plurality of criteria may be evaluated in various configurations in different embodiments of the present invention. The evaluation of the same type of criteria may appear in different profiles and may be prioritized or ranked differently within the different profiles. For instance, FIG. 11 depicts a general overview of a method to determine a bill mix in accordance with an embodiment of the present invention and exemplifies how evaluation of the same type of criteria may occur in different profiles and how the same type of criteria may vary in priority within different profiles. Upon execution, the system of the present invention evaluates at least one criterion pursuant to the default profile based on the set priorities as determined by the location or business where the cash dispenser or kiosk is located. If the evaluated criterion exists, the system is referred to an additional profile for evaluation. The evaluation and profile reference continues until no further reference is possible. A dispense definition, which is comprised of an “include at least” definition or a “minimum definition,” for the currently evaluated profile is then used for the bill mix determination. If a remainder exists after the minimum definition is applied to the transaction amount, a remainder definition may then be used to calculate the remainder bill mix based on a customized or existing bill mix methodologies. For example, after the minimum definition is applied to the dispense amount, the remainder could be calculated using a “least note” methodology.

As depicted in FIG. 11, the bill mix is first determined pursuant to default profile 500, which includes: receiving a transaction request (action 100) and evaluating day and time of the transaction (action 200), which are the first priority criteria in this embodiment. This embodiment of the invention is comprised of evaluating day and time of the transaction collectively in action 200. In such embodiments, the evaluation of whether the day and time criteria exist may involve assessing whether the day and time fall into a predetermined range or category such as: (i) weekday 12:00 a.m. to 5:59 p.m., (ii) weekday 6:00 p.m. to 11:59 p.m., or (iii) weekend day 12:00 a.m. to 11:59 p.m. However, alternate versions of the invention are comprised of evaluating day of transaction and time of transaction as separate evaluations such as in the embodiment of the invention depicted in FIG. 9. In further embodiments of the invention, either day of the transaction or time of the transaction may be evaluated. For instance, FIG. 10 illustrates an embodiment wherein time of the transaction is evaluated, but day of the transaction is not evaluated. Thus, day of the transaction and time of the transaction are both not required to be evaluated in some embodiments of the invention. Accordingly, day of the transaction and/or time of the transaction may be evaluated to determine a bill mix in accordance with the present invention.

Referring back to action 200 of FIG. 11, if the predetermined day and time criteria do not exist, the bill mix determination continues by evaluating transaction type (action 520); evaluating the transaction amount (action 800) if the predetermined transaction type criteria do not exist; evaluating patron information (action 550) if the predetermined transaction amount criteria do not exist; evaluating inventory level (action 560) if the predetermined patron information criteria do not exist; and using the default dispense definition to determine the bill mix (action 590) if the predetermined inventory level criteria do not exist.

If the predetermined day and time criteria do not exist after evaluating day and time of the transaction (action 200), and if either: the predetermined transaction type criteria exist after evaluating transaction type (action 520), the predetermined transaction amount criteria exist after evaluating transaction amount (action 800), the predetermined patron information criteria exist after evaluating patron information (action 550), or the predetermined inventory level criteria exist after evaluating inventory level (action 560), then the bill mix would be determined pursuant to additional respective profiles not illustrated in FIG. 11.

However, if the predetermined day and time criteria does exist after evaluating day and time of the transaction (action 200), then the bill mix would be determined pursuant to additional profiles 410, 420, or 430, each of which correspond to a predetermined day and time of the transaction. For example, the predetermined day and time of the transaction may be comprised of a predetermined day and time range such as: (i) weekday 12:00 a.m. to 5:59 p.m., (ii) weekday 6:00 p.m. to 11:59 p.m., or (iii) weekend day 12:00 a.m. to 11:59 p.m., which would correspond to additional profiles 410, 420, or 430, respectively. Profiles 420 and 430 are comprised of dispense definition 2 and dispense definition 3, respectively, and profiles 420 and 430 do not include further evaluation procedures to evaluate other criteria. Therefore, if the day and time of the transaction corresponds with either profiles 420 or 430, then the bill mix would be determined pursuant to dispense definition 2 or dispense definition 3, respectively.

Referring to action 200 of FIG. 11, if the day and time of the transaction correspond to profile 410, then the bill mix would be determined pursuant to profile 410, which includes additional evaluation procedures to evaluate other criteria to determine a bill mix. Profile 410 includes: evaluating the transaction amount (action 412); evaluating inventory level (action 414) if the predetermined transaction amount criteria do not exist; evaluating transaction type (action 416) if the predetermined inventory level criteria do not exist; evaluating patron information (action 418) if the predetermined transaction type criteria do not exist; and determining the bill mix pursuant to dispense definition 1 (action 419) if the predetermined patron information criteria do not exist.

Still referring to profile 410 of FIG. 11, if either: the predetermined transaction amount criteria exist after evaluating transaction amount (action 412), the predetermined inventory level criteria exist after evaluating inventory level (action 414), or the predetermined patron information criteria exist after evaluating patron information (action 418), then the bill mix would be determined pursuant to additional respective profiles not illustrated in FIG. 11. If the predetermined transaction type criteria exist after evaluating transaction type (action 416), then the bill mix is determined pursuant to profiles 610, 620, or 630, which correspond to transaction type 1, transaction type 2, and transaction type 3, respectively. Profiles 620 and 630 are comprised of transaction type 2 dispense definition and transaction type 3 dispense definition, respectively, and profiles 620 and 630 do not include further evaluation procedures to evaluate other criteria. Therefore, if the transaction type corresponds with either profiles 620 or 630, then the bill mix would be determined pursuant to transaction type 2 dispense definition and transaction type 3 dispense definition, respectively.

Still referring to FIG. 11, profile 610 includes additional evaluation procedures to evaluate other criteria to determine a bill mix. If the transaction type is ‘transaction type 1,’ then the bill mix would be determined pursuant to profile 610 which includes: evaluating inventory level (action 612); evaluating transaction amount (action 614) if the predetermined inventory level criteria do not exist; evaluating patron information (action 616) if the predetermined transaction amount criteria do not exist; and determining the bill mix pursuant to transaction type 1 dispense definition (action 619) if the predetermined patron information criteria do not exist. If either: the predetermined inventory level criteria exist after evaluating inventory level (action 612), the predetermined transaction amount criteria exist after evaluating transaction amount (action 614), or the predetermined patron information criteria exist after evaluating patron information (action 616), then the bill mix may be determined pursuant to additional profiles not illustrated in FIG. 11. Therefore, as illustrated in FIG. 11, the plurality of criteria may be evaluated in various configurations, and the evaluation of the same type of criteria may appear in different profiles and may be prioritized differently within the different profiles.

Any of the foregoing processes to determine a bill mix limit may be included in a bill mix algorithm to be implemented into software and/or a computerized system to execute the method for determining a bill mix of the present invention.

### Examples

In the foregoing description of embodiments of the invention, reference was made to the accompanying figures, which form a part of this application. The figures show, by way of illustration, certain embodiments in which the invention may be practiced. It is to be understood that other variations are possible and modifications may be made without departing from the scope of the present invention. A variety of embodiments are possible wherein each embodiment includes a variation or different combination of the different aspects and elements of the present invention.

For example, in one embodiment, a method for determining a bill mix in an electronic cash dispenser controlling software comprises: (a) receiving a transaction request comprised of a transaction type and a dispense amount; (b) evaluating the transaction type; (c) evaluating the dispense amount; and (d) determining the bill mix according to a dispense definition that is based on a plurality of criteria including the transaction type and the dispense amount. The method may further include: evaluating day of the transaction request wherein the plurality of criteria further includes the day of the transaction request and/or evaluating time of the transaction request wherein the plurality of criteria further includes the time of the transaction request. In any of the above-mentioned versions of the invention, the method may further include: evaluating patron information wherein the plurality of criteria further includes the patron information, evaluating bill inventory level in the electronic cash dispenser wherein the plurality of criteria further includes the bill inventory level in the electronic cash dispenser, and/or receiving patron preference input wherein the plurality of criteria further includes the patron preference input. The patron information may be comprised of player tracking data that is provided by a gaming establishment's player tracking system. Additionally, the dispense definition may include a minimum definition that defines a minimum quantity for each bill denomination to include in the bill mix. If a remainder exists after the minimum definition is applied to the dispense amount, the dispense definition may further include a remainder definition that calculates a remainder bill mix based on a customized or existing bill mix methodology such as a least note methodology.

In another example, an alternate embodiment of the invention is directed to a method for determining a bill mix in an electronic cash dispenser controlling software comprising: (a) receiving a transaction request comprised of a transaction type and a dispense amount; and (b) evaluating a first priority criterion according to a default profile comprised of a first evaluation procedure for the first priority criterion and a default dispense definition wherein the first evaluation procedure comprises (i) determining the bill mix pursuant to an additional profile for a predetermined category if the first priority criterion belongs to the predetermined category and (ii) continuing the bill mix determination pursuant to the default profile if the first priority criterion does not belong to the predetermined category. The default profile may further include a second evaluation procedure for a lower priority criterion. For example, the first priority criterion may be the transaction type and the lower priority criterion may be the dispense amount. The second evaluation procedure may comprise (i) determining the bill mix pursuant to a further profile for a predetermined value if the lower priority criterion is the predetermined value and (ii) continuing the bill mix determination pursuant to the default profile if the lower priority criterion is not the predetermined value. In alternate embodiments, the additional profile may be comprised of a second evaluation procedure for a lower priority criterion. For example the first priority criterion may be day of the transaction request and the lower priority criterion may be time of the transaction request. The default dispense definition may include a minimum definition that defines a minimum quantity for each bill denomination to include in the bill mix. If a remainder exists after the minimum definition is applied to the dispense amount, the dispense definition may further include a remainder definition that calculates a remainder bill mix based on a customized or existing bill mix methodology such as a least note methodology.

In a further example, a method for determining a bill mix in an electronic cash dispenser controlling software is comprised of: (a) identifying a plurality of criteria; (b) prioritizing the plurality of criteria comprised of designating a first priority criterion; (c) receiving a transaction request comprised of a transaction type and a dispense amount wherein the plurality of criteria includes the transaction type and the dispense amount; (d) evaluating the first priority criterion; (e) evaluating the dispense amount; and (f) determining the bill mix. In one version of the invention, the first priority criterion is the transaction type. The plurality of criteria may further include day of the transaction request wherein the first priority criterion is the day of the transaction request. Additionally, the plurality of criteria may further include time of the transaction request and/or patron information such as player tracking data.

Although the present invention has been described above in considerable detail with reference to certain versions thereof, other versions are possible. Some of the actions for determining a bill mix in the methods discussed hereinabove may be modified, added, omitted, or performed in various sequences without departing from the scope of the invention.

While the description above refers to particular embodiments of the present invention, it will be understood that many modifications may be made without departing from the spirit thereof. The presently disclosed embodiments are therefore to be considered in all respects as illustrative and not restrictive.

What is claimed is:

1. A method for determining a bill mix in an electronic cash dispenser, the method comprising:
receiving a transaction request comprised of a transaction type and a dispense amount;
evaluating the transaction type;
evaluating the dispense amount; and
determining the bill mix according to a dispense definition that is based on a plurality of criteria including the transaction type and the dispense amount.

2. The method of claim 1 further comprising evaluating day of the transaction request and the plurality of criteria further includes the day of the transaction request.

3. The method of claim 1 further comprising evaluating time of the transaction request and the plurality of criteria further includes the time of the transaction request.

4. The method of claim 2 further comprising evaluating time of the transaction request and the plurality of criteria further includes the time of the transaction request.

5. The method of claim 1 further comprising evaluating patron information and the plurality of criteria further includes the patron information.

6. The method of claim 4 further comprising evaluating patron information and the plurality of criteria further includes the patron information.

7. The method of claim 1 further comprising evaluating bill inventory level in the electronic cash dispenser and the plurality of criteria further includes the bill inventory level in the electronic cash dispenser.

8. The method of claim 4 further comprising evaluating bill inventory level in the electronic cash dispenser and the plurality of criteria further includes the bill inventory level in the electronic cash dispenser.

9. The method of claim 1 further comprising receiving patron preference input and the plurality of criteria further includes the patron preference input.

10. The method of claim 5 wherein the patron information is comprised of player tracking data that is provided by a player tracking system.

11. The method of claim 1 wherein the dispense definition comprises a minimum definition that defines a minimum quantity for each bill denomination to include in the bill mix.

12. The method of claim 11 wherein if a remainder exists after the minimum definition is applied to the dispense amount, the dispense definition further comprises a remainder definition that calculates a remainder bill mix based on a least note methodology.

13. A method for determining a bill mix in an electronic cash dispenser, the method comprising:
receiving a transaction request comprised of a transaction type and a dispense amount; and
evaluating a first priority criterion according to a default profile comprised of a first evaluation procedure for the first priority criterion and a default dispense definition wherein the first evaluation procedure comprises
determining the bill mix pursuant to an additional profile for a predetermined category if the first priority criterion belongs to the predetermined category and
continuing the bill mix determination pursuant to the default profile if the first priority criterion does not belong to the predetermined category.

14. The method of claim 13 wherein the default profile further comprises a second evaluation procedure for a lower priority criterion.

15. The method of claim 14 wherein the first priority criterion is the transaction type and the lower priority criterion is the dispense amount.

16. The method of claim 14 wherein the second evaluation procedure comprises determining the bill mix pursuant to a further profile for a predetermined value if the lower priority criterion is the predetermined value, and continuing the bill mix determination pursuant to the default profile if the lower priority criterion is not the predetermined value.

17. The method of claim 13 wherein the additional profile is comprised of a second evaluation procedure for a lower priority criterion.

18. The method of claim 17 wherein the first priority criterion is day of the transaction request and the lower priority criterion is time of the transaction request.

19. The method of claim 13 wherein the default dispense definition comprises a minimum definition that defines a minimum quantity for each bill denomination to include in the bill mix.

20. The method of claim 19 wherein if a remainder exists after the minimum definition is applied to the dispense amount, the dispense definition further comprises a remainder definition that calculates a remainder bill mix based on a least note methodology.

21. A method for determining a bill mix in an electronic cash dispenser, the method comprising:
identifying a plurality of criteria;
prioritizing the plurality of criteria comprised of designating a first priority criterion;
receiving a transaction request comprised of a transaction type and a dispense amount wherein the plurality of criteria includes the transaction type and the dispense amount;
evaluating the first priority criterion;
evaluating the dispense amount; and
determining the bill mix.

22. The method of claim 21 wherein the first priority criterion is the transaction type.

23. The method of claim 21 wherein the plurality of criteria further includes day of the transaction request and the first priority criterion is the day of the transaction request.

24. The method of claim 21 wherein the plurality of criteria further includes time of the transaction request.

25. The method of claim 21 wherein the plurality of criteria further includes patron information.
